(19) United States
(12) Patent Application Publication
(10) Pub. No.: US 2004/0151871 A1
(43) Pub. Date: Aug. 5, 2004

(54) Paper machine clothing, especially press felt

(76) Inventor: Dieter Telgmann, Kreuzau, DE (US)

Correspondence Address: Joseph W. Berenato, III, Liniak, Berenato & White, LLC, Suite 240, 6550 Rock Spring Drive, Bethesda, MD, 20817, US

(21) Appl. No.: 10/355,254

(22) Filed: Jan. 31, 2003

(51) Int. Cl. B32B 3/28; B32B 5/12

(52) U.S. Cl. 428/107; 428/109; 442/268; 442/189

(57) ABSTRACT

A paper machine clothing, especially a press felt (1), includes a support (2) which has at least one layer of a thread lap (3, 4, 5, 13) and which is embedded in a fiber matrix. Lap threads (6, 7, 8, 9, 10, 14, 17, 21, 25, 26, 27, 28, 33, 38, 43, 44, 45) run parallel to one another. The lap threads (10, 14, 17) are provided with outwardly projecting fibers (12, 16, 19).

The invention concerns a paper machine clothing, especially a press felt, with a support which has at least one layer of a thread lap with lap threads running parallel to one another, and which is embedded in a fiber matrix.

Paper machine clothes are bands of great length and width circulating in paper machines which serve to form and guide the paper web through the paper machine. Their construction depends greatly upon in which part they are installed in the paper machine. Press felts in which a support is embedded in a fiber matrix are usually for the pressing part in which the previously formed paper web is mechanically dehydrated. The support in particular serves to accommodate the tractive forces acting upon the press felt and is primarily constructed as a fabric whereby the support can be constructed of several support tracks not connected with one another. A fiber fleece is then unilaterally or bilaterally sewn onto this support which provides protection of the support from wear and tear and provides for even surfaces.

Instead of a fabric, thread laps in single and multiple layer construction can also be provided. Such representative press felts can, for example, be gathered from EP-B-0 394 293 and EP-A-0 038 276. The thread laps are distinguished in that they consist of a large number of lap threads running parallel to one another, whereby the lap threads can extend longitudinally as well as transversely. These distances should be as equal as possible and remain constant over the extension of the lap threads so that the dehydration properties of the press felt are even over its surface. Nonetheless, it creates problems in manufacturing such press felts to ensure such equal and constant distances especially during the needle stitching process for the purpose of connecting and fastening the fiber fleece layers (cf. DE-C-40 40 861).

Wrapping lap threads with spun fiber yarns is proposed with the press felt according to EP-0 394 293. Nonetheless, one is restricted with these lap threads to twined threads. Their manufacture is expensive and therewith cost intensive owing to the twining process. The twines cannot be relied upon for manufacture of a wire seam, so that providing a press felt of this type with a seam presents difficulties. Moreover, they lead to a premature thickening of the lap owing to which the dehydration properties worsen.

The invention is based on the objective of developing a paper machine clothing with a thread lap such that the lap threads used with the known press felt with wrapped spun fiber yarns are replaced by more simply and economically manufactured lap threads with basically identical processes, and in this way the possibility of using monofils for these lap threads is also opened.

This object is accomplished in accordance with the invention in that lap threads are provided with outwardly projecting fibers, whereby the fibers should preferably chiefly project vertically in relation to the surface of the lap threads or at an angle of up to 60° in relation to the vertical. Such lap threads replace the lap threads wrapped with spun fiber yarns as they are known from EP-B-0 394 293 at least partially, but preferably completely, whereby not all lap threads need be constructed in this manner, but it is more appropriate. The advantage of such lap threads lies in the fact that they can basically be manufactured more simply and therewith more economically, for example by gluing the threads and here in particular by electrostatic depositing or construction as chenille fibers. This opens up the possibility which previously did not exist with threads wrapped with spun fiber yarn of using monofils of the most varied diameters, preferably in the range between 0.3 and 0.6 mm and giving them the same property which was brought about by wrapping the lap threads with spinning fiber year. Moreover, the projecting threads can be created not only by electrostatic depositing, but also by roughening, especially scraping the material of the monofils.

The use of monofils permits manufacturing the stitch felts on the lap basis because the monofils are suited for forming loops on the end corners of the paper machine clothing and through which these ends can be connected using a wire inserted through the loops. Such seam felts are especially basically easier to insert into the pressing part of a paper machine than press felts manufactured in an endless manner.

Of course, there also exists the possibility of constructing the lap threads with outwardly projecting fibers as twines of individual threads, preferably individual threads of two to twelve monofils with a diameter from 0.1 to 0.4 mm in each case, or as multifilaments. Even these threads can be electrostatically applied. Instead of this, there exists the possibility of clamping the outwardly projecting fibers between the individual fibers.

It is provided in accordance with a further feature the invention in that spacing threads are present which run between two lap threads and are soluble in a solvent in which the remaining part of the paper machine clothing is not soluble. The basic concept of the invention is thus to provide spacing threads between the lap threads (and indeed preferably between all lap threads) which keep the lap threads at a predetermined distance which remains constant over their extension. In this way they stabilize the position of the lap fibers and ensure their even distribution over the surface. Since they are introduced with the manufacture of the support, displacements of the lap fibers do not occur during subsequent manufacturing steps, especially during embedding the support into a fiber matrix, for example by needle stitching of fiber fleeces. That is, their distribution is maintained until finishing the paper machine clothing. Only then are the spacing fibers dissolved out in order to obtain the desired water permeability.

The dissolution out can take place before insertion into the paper machine through a corresponding washing step or, however, first after insertion whereby the dissolution takes place through the liquid pressed out of the paper web during an intake phase. In both cases, it is appropriate for the spacing fibers to be water soluble, whereby in particular threads of polyvinyl alcohol offer themselves. In the end, in this way a paper machine clothing is obtained with a support having at least one fiber lap which is distinguished by very even dehydration properties over the surface.

To be sure, incorporating soluble fibers or threads into paper machine clothes and dissolving them out before insertion into the paper machine or in an intake phase has been known in the state of the art for a long time. This nonetheless took place in order to make the paper machine clothing water-permeable in general or to enlarge its internal hollow spaces to such an extent that this could not be reached through normal manufacturing processes, and in this way to enlarge the dehydration output (cf. U.S. Pat. No. 4,482,601, EP-B-0 466 990, EP-A-0 567 206, EP-B-0 413 869; WO 98/07925; EP-A-0 123 431; DE-A-24 37 303; DE-U-70 31 398). Moreover, such fibers were also used which are not soluble when inserted into the paper machine and which were first removable through a separate washing scouring solution. The reason for this measure was to restore the original water permeability reduced by contamination again. In both cases, the goal is not comparable with that which is the basis of the present invention.

In a first development of the basic conception of the invention, the spacing threads run parallel to the lap threads. That is the lap threads and the spacing threads lie side by side, whereby it is apparent that have a constant cross section over their extension. Moreover, as a rule, one spacing thread between two lap threads suffices so that one lap fiber always alternates with one spacing thread. As an alternative, it can be provided that the spacing threads are in each case wrapped around a lap fiber or entwined with this such that they project externally. In this way, the threads come to lie point by point upon one another, and indeed the spacing threads when all lap threads are wrapped or are entwined with spacing fibers, or by one spacing thread and one lap thread in any given case when only every second lap thread is wrapped by a spacing thread or is entwined with it. This point by point contact can be transformed into a line contact if the lap threads are wrapped completely by the spacing fibers and are constructed, for example, as surface threads or bands.

According to a further feature of the invention, it is provided that the lap threads are enveloped or entwined with a spun fiber yarn such as provided, for example, in the paper machine clothing according to EP-B-0 394 293.

In order to improve the dehydration properties even further, it is provided in accordance with the invention that a part or all lap threads are constructed as contoured monofils. They thus have an off round cross section in which the profile runs screw-like or spiral-like viewed in the longitudinal direction of the monofil. The respective monofil is thus rotated about its long axis with respect to its outer configuration. A part of these or all these monofils can also be provided with outwardly projecting fibers, especially be electrostatically provided with these.

By using the screw-like contoured lap threads of the invention, the open volume inside the paper machine clothing is increased and better dehydration properties result. The effect can be varied by the number, construction and arrangement of these lap threads to a considerable extent and therewith adapted to the standards in question. Moreover, it does not depend upon whether the lap threads stand under torsion tension inside the paper machine clothing. They are thus twisted only after their manufacture and have been inserted into the paper machine clothing in this condition, or if the screw-like contouring was already impressed during manufacture, for example during extrusion through appropriate nozzle shapes or during subsequent stretching. For this reason, the monofils lie without tension in the paper machine clothing. Such screw-like contoured monofils are suited for replacing twines which must be separately manufactured from monofils or multifils.

Using flat threads rectangular in cross section or other cross section shapes of threads as well for the supports of paper machine clothes which are in part strongly contoured for specified purposes is indeed known. (Cf. DE-A-40 31 608; U.S. Pat. No. 5,361,808; DE-A-195 45 386; U.S. Pat. No. 5,591,525; EP-A-1 067 239, DE-A-199 00 989.) The contouring of these threads moreover takes place for the most varied of reasons. Nonetheless, common to all threads is that the contour is longitudinally stretched, thus extended in the axis of the respective thread and is consequently not twisted.

Great freedom exists with respect to the construction of the cross sections of the screw-like contoured monofils. They thus can have an oval, trilobate, polygonal, square, rectangular, clover-leaf and/or triangular cross section, whereby the cross sections need not even be regular or symmetrical. Moreover, monofils of different cross section can also be present in order correspondingly to exert an influence on the pore volumes and therewith assume the dehydration properties in accordance with the standards. An especially high pore volume results when screw-like contoured monofils are present, the cross section of which has several down warpings over its periphery. In contrast, however, up warpings distributed over the periphery can also be provided, or both can be combined with each other such that down and up warpings are alternatingly distributed over the periphery. Moreover, sharp or rounded off corners running screw-like can also be provided.

It has proven to be beneficial if the contour of the screw-like contoured monofils has two to forty threads over 10 cm, thus that the cross section of the monofils is twisted two to forty times in this length. But the volume of the pores and therewith the dehydration properties can also be influenced through the number of threads. Here monofils with a different number of threads can also be provided.

Influence on the pore volume and therewith the dehydration capacity can also be exerted through the number of screw-like contoured monofils. Appropriately at least 30% of the lap threads extending longitudinally and/or transversely should be screw-like contoured monofils, whereby also all longitudinally and/or transverse threads can be such monofils.

Basically, there also exists the possibility of processing the screw-like profiled monofils into twines, for example such that several screw-like contoured monofils are entwined with one another. But there also exists the possibility of entwining one or more screw-like monofils with monofils shaped in another manner, for example stretched contoured monofils or round monofils and/or multifilaments.

There exist no restrictions with respect to the layer characteristic of the support. That is, the support can be constructed with one layer or many layers or can also consist of several support tracks not connected with one another through threads, which are identically constructed or are also different. Moreover, the support can also have a woven fabric, knitted fabric and/or a network as long as a layer of thread lap is present.

It is advantageous for use in a press felt if the support is embedded into a fiber matrix in which it is enclosed between at least two fiber layers which are needle stitched with each other. As regards the material of the lap threads, materials typical for paper machine clothes can be used. These are in particular thermoplastic polymers, for example polypropylene, polyamide 4.6, polyamide 6, polyamide 6.6, polyamide 6.10, polyamide 6.12, polyamide 12, PET, PTT, PPS, PEK or PEEK. Even elastomer polyesters are usable.

The invention is illustrated in greater on the basis of embodiments in the drawing, wherein:

FIG. 1 Is a cross section through a press felt with thread laps as supports;

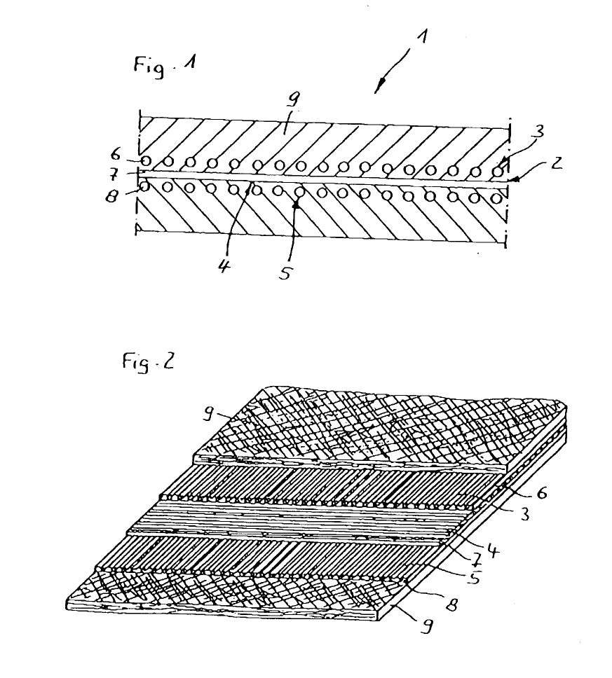

FIG. 2 Illustrates a partial section of the press felt in accordance with FIG. 1 in three quarters view, whereby in each case the upper layer is shortened in relation to in each case the lower layer;

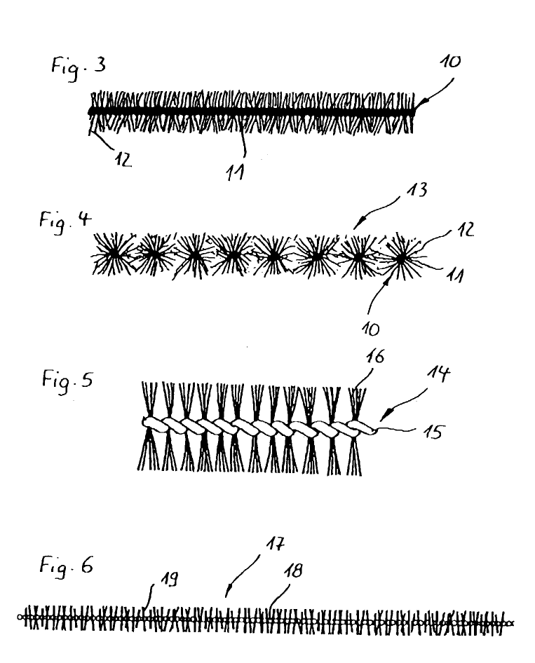

FIG. 3 Shows an electrostatically applied lap thread;

FIG. 4 Depicts a cross section through a thread lap with electrostatically applied lap threads;

FIG. 5 Is a view of a lap thread constructed as twine with clamped fibers;

FIG. 6 Illustrates a lap thread constructed as chenille thread;

FIG. 7 Shows a component of a lap thread constructed as a screw-like contoured monofil;

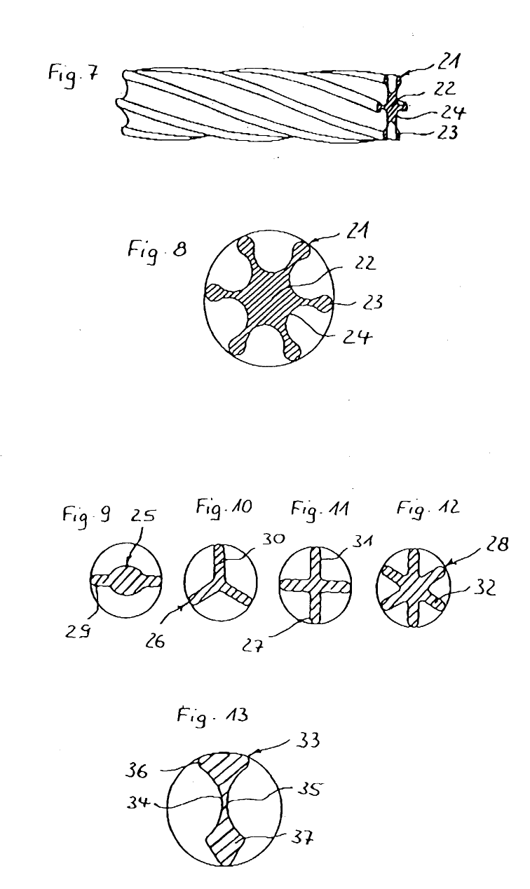

FIG. 8 Depicts a cross section through the lap thread in accordance with FIG. 7;

FIGS. 9 through 17 Reveal different cross sections of lap threads which are constructed as screw-like contoured monofils.

The press felt 1 shown in FIGS. 1 and 2 has a support 2 which consists of three layers laid one over the other which are constructed in each case as thread laps 3, 4, 5. All three thread laps 3, 4, 5 in each consist of lap threads running parallel on the plane of the press felt 1 (designated by way of example with 6, 7, 8) which in each case have the same distance from one another. The lap threads 6, 8 of upper and lower thread laps moreover run in the longitudinal direction of the press felt 1 which at the same time is its direction of travel, while the lap threads 7 of the central thread lap 4 extend transversely in relation thereto. The support 2 is embedded in the middle of a fiber matrix 9 which is represented merely by layer in FIG. 2 and arose by needle stitching of fiber fleeces.

The press felt 1 can already be seen in its final state. The distances between the lap threads 6, 7, 8 are characteristic. These distances were brought about in that spacing threads were worked in between the lap threads 6, 7, 8 already during manufacture of the support 2, the extension of which in the plane of the respective thread laps 3, 4, 5 corresponded to the now free distance between lap threads 6, 7, 8 to be recognized in FIGS. 1 and 2. Moreover, the spacing threads can have a square or rectangular cross section in order to avoid a sliding one over the other of spacing threads and lap threads 6, 7, 8.

The support 2 is then covered with fiber fleeces and run through a needle machine in which the fiber fleeces are interlocked with and fastened to one another while forming a fiber matrix 9. Moreover the spacing threads have ensured that displacements of the lap threads 6, 7, 8 has not occurred. Subsequently the spacing threads have been dissolved under the action of a solvent (water can be used as a solvent with spacing threads of polyvinyl alcohol), on account of which the free spaces between lap threads 6, 7, 8 resulted.

FIG. 3 depicts in side view a lap thread 10 which has a monofil 11 which is electrostatically covered with fibers basically projecting vertically from its surface, designated by way of example with 12.

FIG. 4 depicts a thread lap 13 with lap threads 10 in accordance with FIG. 3, whereby the thread lap 13 consists of a large number of lap threads 10 arranged alongside one another running parallel to one another, which have the same distances from one another.

FIG. 5 shows a lap thread 14 which consists of a twine 15 with clamped fiber sheaves projecting vertically between the individual threads of the twine 16, designated with 16 by way of example. It is obvious that these fiber sheaves 16 are distributed over the periphery, to be seen similar to the case of the thread lap 13.

FIG. 6 depicts a lap thread 17 which is constructed as a chenille thread with a core thread 18 and fibers basically projecting vertically from it, designated by way of example with 19.

A lap thread 21 is represented in FIGS. 7 and 8 which is constructed as a monofil and is constructed with a rotation symmetrical cross section with a core 22 and a total of six radially outwardly projecting bars, designated by way of example with 23. The bars 23 are enclosed between deep downward warpings-designated by way of example with 24—which form grooves over the length with the lap thread 21.

As is apparent from FIG. 7, the contour of the lap thread 21 is configured screw-like thus, inwardly twisted on the basis of its outer configuration, so that the bars 23 and also the grooves formed by the downward warpings 24 run screw-like about the core 22 of the lap thread 21. If such lap threads 21 are incorporated into the support of a paper machine clothing, there arises a pore volume owing to this whereby the grooves formed by the downward warpings 24 form dehydration channels.

Other embodiments of lap threads 25, 26, 27, 28 are represented in FIGS. 9 to 12. They are likewise rotation-symmetrical and have a different number of radially running bars, designated as 29, 30, 31, 32 by way of example.

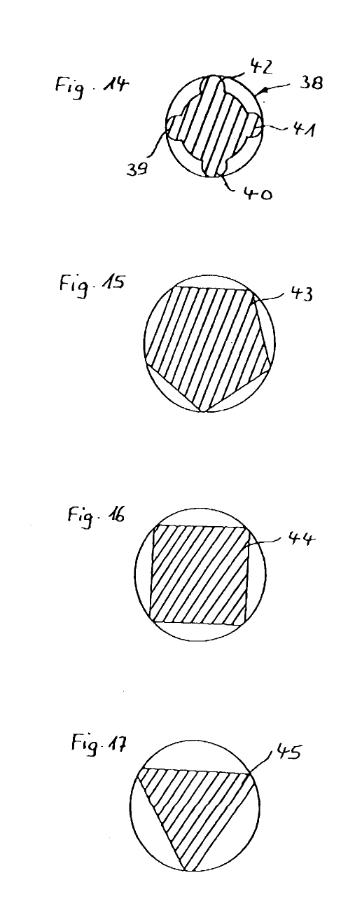

A lap thread 33 is disclosed in FIG. 13 which is only mirror-symmetrical. It has two opposed downward warpings 34, 35 which run bilaterally into thickenings 36, 37 of different shape.

A screw-like configured lap thread 38 is represented in FIG. 14 which is constructed rotation-symmetrical and has four upward warpings 39, 40, 41, 42 distributed over the periphery, whereby the upward warpings 39, 40, 41, 42 are connected through convex regions. Groove-like depressions also result with this contour.

Further screw-like contoured lap threads 43, 44, 45 are represented in cross section in FIGS. 15 to 17, and indeed with a regular pentagon (FIG. 15), a square (FIG. 16) and a triangle (FIG. 17). Even if the connection of the corners or edges of these lap threads 43, 44, 45 form trenches, pore volumes and dehydration channels arise through the screw-like contour.

We claim:

1. Paper machine clothing, especially a press felt (1), with a support (2) which has at least one layer of a thread lap (3, 4, 5, 13) with lap threads (6, 7, 8, 9, 10, 14, 17, 21, 25, 26, 27, 28, 33, 38, 43, 44, 45) running parallel to one another, characterized in that lap threads (10, 14, 17) are provided with outwardly projecting fibers (12, 16, 19).

2. Paper machine clothing according to claim 1, characterized in that the fibers (12, 16, 19) predominantly project at an angle toward the surface of the lap threads (10, 14, 17) which deviates from 0° to 60° from vertical to the surface.

3. Paper machine clothing according to claim 1 or 2, characterized in that the fibers (12) are glued to the lap threads (10).

4. Paper machine clothing according to claim 3, characterized in that the fibers (12) are electrostatically applied.

5. Paper machine clothing according to one of claims 1 to 4, characterized in that lap threads (14) are constructed as chenille threads with outward projecting fibers.

6. Paper machine clothing according to one of claims 1 to 5, characterized in that the fibers (12, 16, 19) have a length of at least 0.5 mm, preferably 1 to 1.6 mm.

7. Paper machine clothing according to claims 1 to 6, characterized in that the lap threads (10) are constructed as monofils with outwardly projecting fibers.

8. Paper machine clothing according to claim 7, characterized in that the monofils have a diameter from 0.3 to 0.6 mm.

9. Paper machine clothing according to claim 7 or 8, characterized in the monofils are roughened such that outwardly projecting fibers are formed from their material.

10. Paper machine clothing according to one of claims 1 to 9, characterized in that the lap threads (14) are constructed as twines of individual threads with outward projecting fibers.

11. Paper machine clothing according to one of claim 10, characterized in that the twines consist of two to twelve monofil individual fibers with a diameter from 0.1 to 0.3 mm in each case.

12. Paper machine clothing according to one of claim 10 or 11, characterized in that the twines are constructed as multifilaments.

13. Paper machine clothing according to claim 10 or 11, characterized in that outwardly projecting fibers (16) are clamped between the individual threads.

14. Paper machine clothing according to claims 1 to 13, characterized in that spacing threads are present which run between two lap threads (6, 7, 8, 10, 14, 17, 21, 25, 26, 27, 28, 33, 38, 43, 44, 45) and are soluble in a solvent in which the remaining part of the paper machine clothing (1) is not soluble.

15. Paper machine clothing according to one of claim 14, characterized in that the spacing threads run parallel to the lap threads (6, 7, 8, 9, 10, 14, 17, 21, 25, 26, 27, 28, 33, 38, 43, 44, 45).

16. Paper machine clothing according to claim 14 or 15, characterized in that the spacing threads are in any given case so wrapped about a lap thread or are entwined with this such that it projects outwardly.

17. Paper machine clothing according to claims 14 to 16, characterized in that the spacing threads are water-soluble.

18. Paper machine clothing according to one of claims 14 to 17, characterized in that lap threads are wound or entwined with spun fiber yarn.

19. Paper machine clothing according to one of claims 1 to 18, characterized in that lap threads (21, 25, 26, 27, 28, 33, 38, 43, 44, 45) are constructed as screw-like contoured monofils.

20. Paper machine clothing according to claim 19, characterized in that screw-like contoured monofils (21, 25, 26, 27, 28, 33, 38, 43, 44, 45) are present which have an oval, trilobate, polygonal, square, rectangular, cloverleaf and/or triangular cross section.

21. Paper machine clothing according to claim 19 or 20, characterized in that screw-like contoured monofils (21, 33) are present, the cross section of which has downward warpings (24, 34, 35) distributed over its periphery.

22. Paper machine clothing according to one of claims 19 to 21, characterized in that screw-like contoured lap threads (38) are present the cross section of which has several upward warpings (39, 40, 41, 42) distributed over its periphery.

23. Paper machine clothing according to claim 21 and 22, characterized in that screw-like contoured lap threads are present the cross section of which has downward and upward warpings alternatingly distributed over its periphery.

24. Paper machine clothing according to claim 23, characterized in that screw-like contoured lap threads are present which are provided with outwardly projecting fibers.

25. Paper machine clothing according to one of claims 19 to 24, characterized in that screw-like contoured lap threads (21) are present the contour of which has screw-like running sharp corners.

26. Paper machine clothing according to one of claims 19 to 25, characterized in that the contour of the screw-like contoured lap threads (21) the contour of which has screw-like running rounded off edges.

27. Paper machine clothing according to one of claims 19 to 26, characterized in that the contour of the screw-like contoured lap threads (21, 25, 26, 27, 28, 33, 38, 43, 44, 45) have two to forty threads over 10 cm of length.

28. Paper machine clothing according to one of claims 1 to 27, characterized in that at least 30% of the lap threads extending longitudinally and/or transversely are screw-like contoured monofils (21, 25, 26, 27, 28, 33, 38, 43, 44, 45).

29. Paper machine clothing according to one of claims 19 to 28, characterized in that twines are present in which several screw-like contoured monofils are entwined with one another or at least one screw-like contoured monofil is entwined with other monofils and/or multifilaments.

30. Paper machine clothing according to one of claims 1 to 29, characterized in that the support is constructed in one layer or several layers.

31. Paper machine clothing according to one of claims 1 to 30, characterized in that the support consists of several support tracks (2, 4, 5) not connected among one another by threads.

32. Paper machine clothing according to one of claims 1 to 31, characterized in that the support has a woven fabric, a knitted fabric and/or a network and additionally a thread lap.

33. Paper machine clothing according to One of claims 1 to 32, characterized in that the support (2) is enclosed between at least two fiber layers.

34. Paper machine clothing according to one of claims 1 to 32, characterized in that the lap threads (6, 7, 8, 10, 14, 17, 21, 25, 26, 27, 28, 33, 38, 43, 44, 45) and if need be the spun fiber yarns are made of a thermoplastic polymer such as polypropylene, polyamide 4,6, polyamide 6, polyamide 6.6, polyamide 6.10, polyamide 6.12, polyamide 11, polyamide 12, PET, PTT, PBT, PPS, PEK, PEEK or an elastomer polyester.
